(19) United States
(12) Patent Application Publication
(10) Pub. No.: US 2016/0376114 A1
(43) Pub. Date: Dec. 29, 2016

(54) Pneumatic Bottle Delivery System

(71) Applicant: HUMANA INC., Louisville, KY (US)

(72) Inventors: Michael Mahar, Phoenix, AZ (US); Atin Kapadia, Chandler, AZ (US)

(73) Assignee: HUMANA INC., Louisville, KY (US)

(21) Appl. No.: 14/067,621

(22) Filed: Oct. 30, 2013

Related U.S. Application Data
(60) Provisional application No. 61/720,070, filed on Oct. 30, 2012.

(51) Int. Cl. B65G 51/02

(52) U.S. Cl. CPC B65G 51/02

(57) ABSTRACT

A pneumatic bottle delivery system for transporting pharmaceutical bottles from a main shared storage “hopper” or storage bins to several individual locations as needed. A network of sensors and control gates detect and distribute the flow of bottles to individual locations dependent upon the bottle queue at each location.

This application claims the benefit of U.S. Provisional Patent Application Ser. No. 61/720,070, filed on Oct. 30, 2012, titled Pneumatic Bottle Delivery System, which is incorporated herein by reference.

### BACKGROUND OF THE INVENTIVE FIELD

The present invention is directed to a bottle or vial delivery system and process. More particularly, the preferred embodiment of the present invention relates to a pneumatic bottle delivery system for transporting pharmaceutical bottles from a main shared storage “hopper” or storage bins in an isolated area to several individual labelers mounted directly above the conveyor production line.

The preferred embodiment of the present invention allows for a higher volume of bottle transport while increasing storage volume capacity of the traditional bottle storage hoppers which reduces the frequency of manual replenishment of the bottle storage area (e.g., lower bottle replenishment intervals).

The present invention also relates to an improved method and system for distributing bottles to the desired locations, for example, distributing the bottles to individual labelers. In the preferred embodiment, this distribution method and system can be controlled at varying rates based on the required production output.

### SUMMARY OF THE GENERAL INVENTIVE CONCEPT

In one embodiment of the present invention, a pneumatic bottle delivery system transports pharmaceutical bottles from a main storage hopper in an isolated area to several individual labelers mounted directly above the conveyor production line.

In one embodiment, for example, three large bottle hoppers are dedicated to this transport system. In this example, each hopper has an individual bottle orientation device and an inlet air pipe adjacent to the bin that enables distribution of the bottles to sub-sets of three to four labelers—supporting a total number of twelve.

In the preferred embodiment, a network of sensors and control gates detect and distribute the flow of bottles to individual labelers dependent upon the bottle queue at each labeler. Accordingly, the present invention provides the ability to replenish bottles from a separate storage location and feed multiple labelers simultaneously. More specifically, the preferred embodiment of the system provides the ability to utilize the feed process from one storage hopper to distribute bottles to several labelers, gaining the ability to shift distribution flow to labelers with the greatest replenishment need.

With the development of this transport system, greater storage volumes were created with correspondingly reduced manual bottle replenishment intervals. In the example embodiment discussed, bottle replenishment can be reduced to once or twice daily. This feature enables greater system flexibility under scenarios of higher production rates or movement of bottles.

### BRIEF DESCRIPTION OF THE DRAWINGS

The following detailed description of the example embodiments refers to the accompanying figures that form a part thereof. The detailed description provides explanations by way of exemplary embodiments. It is to be understood that other embodiments may be used having mechanical and electrical changes that incorporate the scope of the present invention without departing from the spirit of the invention.

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates one embodiment of the system of the present invention;

FIG. 2 illustrates one embodiment of the hopper or storage bin assembly of the present invention loaded with pill bottles;

FIG. 3 illustrates one embodiment of the bottle orientation device of the present invention;

FIG. 4 illustrates one embodiment of the control gate; and

FIG. 5 illustrates one embodiment of the control gate portion of the invention demonstrating a vial feed tube and output tubes to the various labelers.

### DETAILED DESCRIPTION OF EXEMPLARY EMBODIMENT(S)

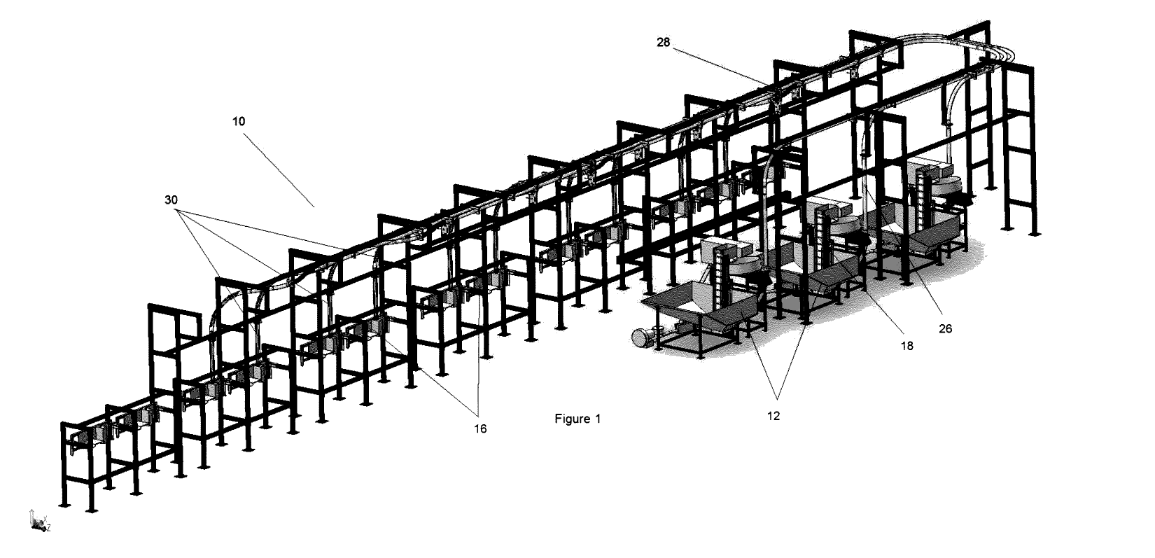

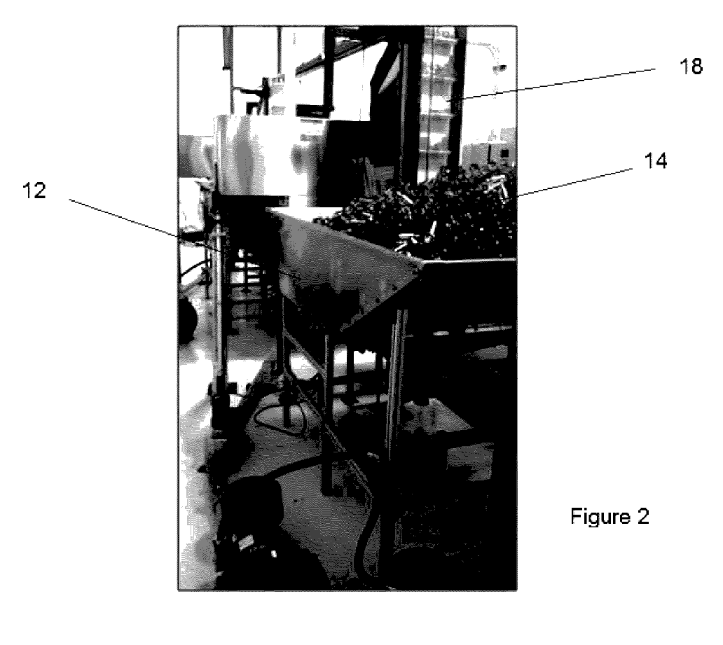

FIG. 1 illustrates one embodiment of the bottle storage and delivery system of the present invention 10. In the preferred embodiment, the hoppers 12 store the pill bottles 14 in a designated area, preferably at a distance from the labelers 16. In one embodiment, there is a plurality of hoppers, e.g., three hoppers. FIG. 2 illustrates one embodiment of the hopper or storage bin assembly of the present invention loaded with pill bottles. In one embodiment, bottles are extracted from the hoppers using an elevator feed mechanism 18 to start the delivery process.

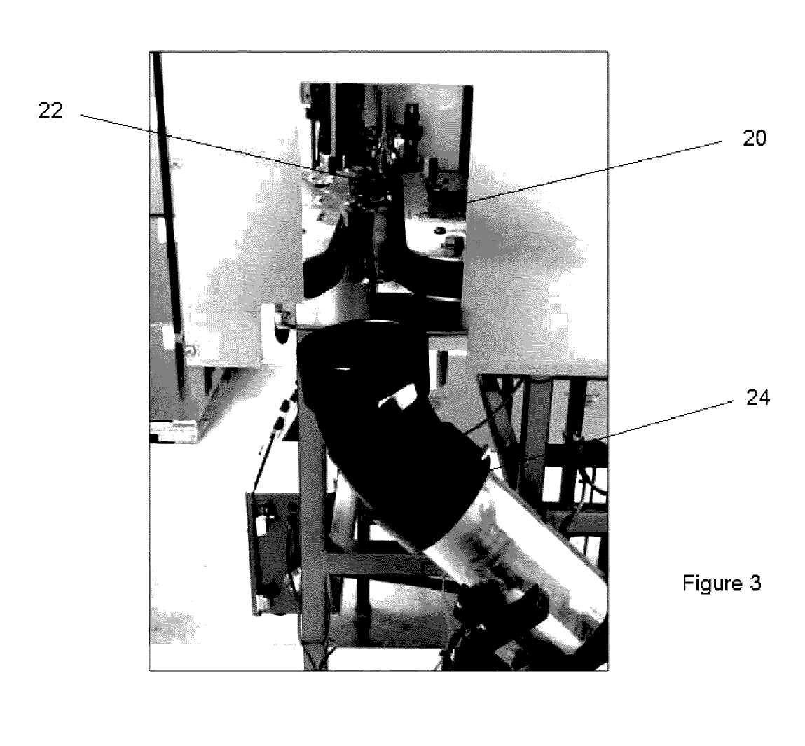

The pill bottles then tumble into the orientation device 20 where they are all situated with the openings 22 facing upward and are dropped into an inlet tube 24 for distribution to the labelers. FIG. 3 illustrates one embodiment of the bottle orientation device of the present invention and the inlet tube.

The bottles are held in the inlet tube until a signal is received to replenish a specific labeler served by that hopper. For example, in one embodiment, each hopper has a dedicated pneumatic tube 26 feeding a sub-set of three to four labelers. When the queue is short at a labeler, the bottles in the staging area inlet tube are released into the adjacent high pressure pneumatic line for delivery.

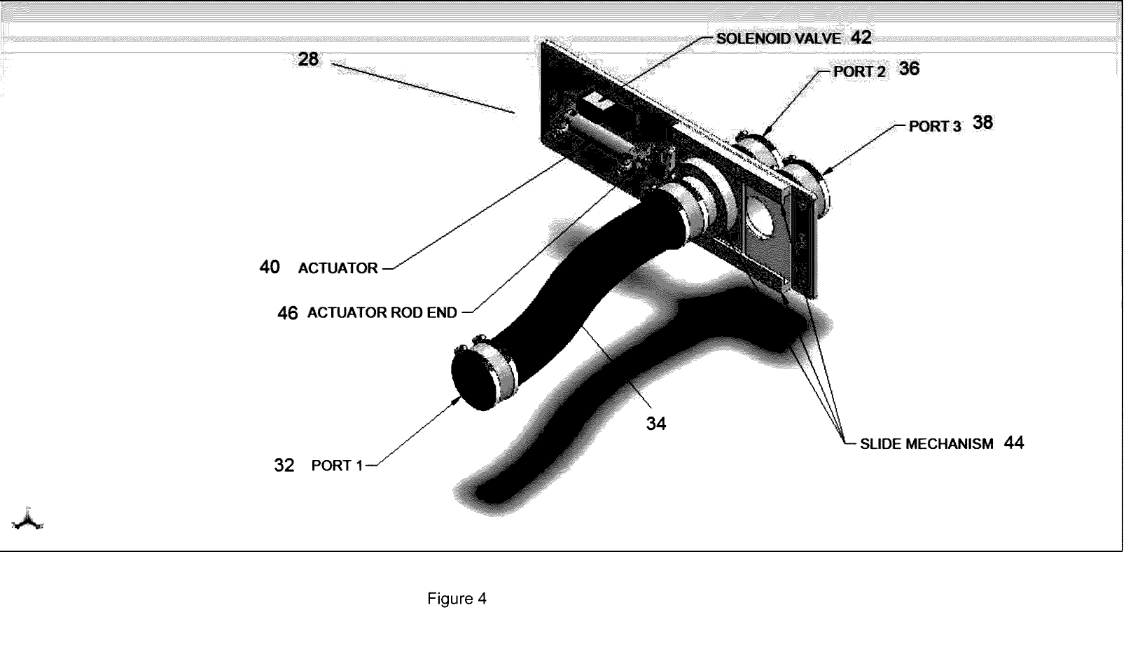

At approximately the midpoint between the storage hopper and the labelers, control gates 28 actuate a flexible portion of the high pressure line to direct bottles to different tubes 30 that travel to a destination labeler. FIG. 4 illustrates one embodiment of the control gate. In the sample embodiment shown, the valve functions as a three way valve. The valve has three ports. Port 1 32 is attached to a flexible tube 34 and is the port where the vials are entering from. Port 2 36 is attached to an outgoing tube that conveys vials to one the labelers in the group or to another control gate. Port 3 38 is attached to another outgoing tube that also conveys vials to one the labelers in the group or to another control gate. In one position, Port 1 is connected to Port 2 and in the other position Port 1 is connected to Port 3. It is understood that in other embodiments, a larger valve may be used with more than three valves or ports.

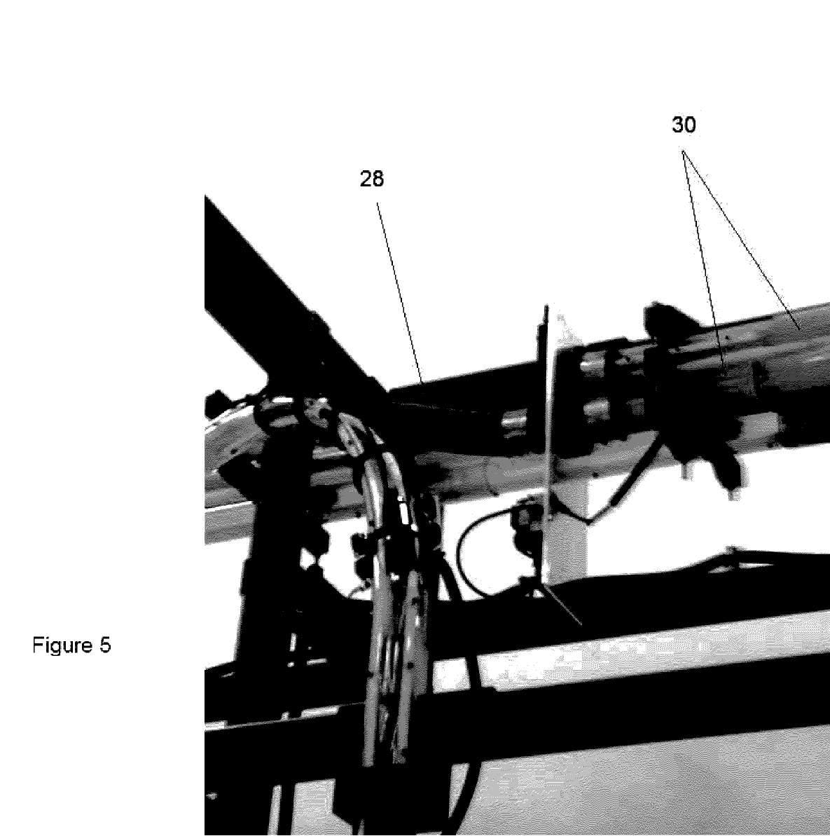

In the embodiment shown in FIG. 4, the valve consists of a pneumatic cylinder (actuator) 40, a solenoid valve 42 to control the actuator and a slide mechanism 44. In operation, compressed air is supplied to the solenoid valve. The solenoid valve then delivers the compressed air to the one end of the actuator or the other. When air is supplied to the bottom of the actuator, it will extend; when air is supplied to the rod end 46 of the actuator it will retract. The solenoid valve is controlled by the software that commands the solenoid to what position to place the valve. FIG. 5 illustrates one embodiment of the control gate portion of the invention demonstrating the installation of a control gate between a feed tube and output tubes that lead to the various labelers.

In the preferred embodiment, a network of sensors and control gates detect and distribute the flow of bottles to individual labelers dependent upon the bottle queue at each labeler. Accordingly, the present invention provides the ability to replenish bottles from a separate storage location and feed multiple labelers simultaneously. More specifically, the preferred embodiment of the system provides the ability to utilize the feed process from one storage hopper to distribute bottles to several labelers, gaining the ability to shift distribution flow to labelers with the greatest replenishment need. For example, if a sensor located at a first labeler determines that the bottle queue is short, the control system is programmed to generate a signal to the control gate to deliver more bottles to the first labeler. In the preferred embodiment, the system can deliver a predetermined number of bottles to the first labeler by controlling the system.

For example, for each labeler, the bottle tube holding the bottles has three photo-eye (photoelectric) sensors (high, middle, and low). The level of vials in the tube is monitored by these sensors, which are connected to a control program. When the “high” PE does not see a vial, the control program will release a small number of vials from the blower. When either the “medium” or “low” PEs does not see a vial then the control program will release a larger number of vials. In one embodiment, the control system is a “soft-plc” that serves as a translation layer between the hardware and software control system with some logic capabilities. In the preferred embodiment, the blower is not constant and operates on-demand depending on the vial levels at the labeler.

In one example embodiment, each blower is connected to a set of labelers. Blower 1 is connected to labelers 3, 6 and 9. Blower 2 is connected to labelers 1, 4, 7 and 11. Blower 3 is connected to labelers 2, 5, 8 and 10. Swing gates are used to divert the vials to the proper labeler. For example, there will be a swing gate before labeler 3 that can swing from labeler 3 towards labelers 6 and 9, and another one before labeler 6 that can swing from labeler 6 to labeler 9. By default, the swing gates will be open towards the nearest labeler (labeler 3 for example). This way, higher pressure may be obtained for pushing the vials. If the vials need to get to a farther labeler (labeler 6 for example), the swing gate will preferably move to that labeler's position sometime after the blower releases the vials (e.g., 0.8 second after releasing vials).

While certain embodiments of the present invention are described in detail above, the scope of the invention is not to be considered limited by such disclosure, and modifications are possible without departing from the spirit of the invention. For example, the method and system can be used for transporting other types of bottles other than pill bottles or may be used to transport other types of objects from storage locations to other desired locations.

1. A bottle delivery system for delivering bottles stored in a storage container to a set of bottle labelers, comprising:
a first control gate, comprised of a first input port, a first and second output port, a valve for connecting the first input port to the first output port in a first position, and for connecting the first input port to the second output port in a second position;
a first input tube connected to the first input port for delivering bottles to the first input port;
a first output tube connected to the first output port wherein bottles are delivered to the first output tube when the valve of the first control gate is in a first position;
a second output tube connected to the second output port wherein bottles are delivered to the second output tube when the valve of the first control gate is in a second position;
a first bottle labeler connected to the first output tube;
a first sensor located at a first location at the first bottle labeler for detecting the presence of a bottle at the first location;
a processing system in communication with the first sensor, the processing system programmed with one or more software routines executing on the processing system to: 1) receive input from the first sensor at the first bottle labeler; 2) determine if the bottle queue is short at the first location; and 3) output a control signal to the first control gate to deliver a predetermined number of bottles when the bottle queue at the first location is short, wherein the system will deliver bottles from the storage container to the first labeler when the first sensor determines the first bottle labeler needs more bottles.

2. The bottle delivery system according to claim 1, further comprising:
a plurality of storage containers for storing bottles for delivery;
a plurality of bottle labelers; and
a plurality of control gates for controlling the delivery of bottles from the plurality of storage containers to the plurality of bottle labelers.

3. The bottle delivery system according to claim 1, further comprising:
a bottle orientation device for feeding the bottles into the first input tube with openings of the bottles pointing up.

4. The bottle delivery system according to claim 1, further comprising:
a blower for providing air to the system.

5. The bottle delivery system according to claim 1, further comprising:
a second sensor located at a second location at the first bottle labeler for detecting the presence of a bottle at the second location at the first bottle labeler; and wherein the processing system is programmed with one or more software routines executing on the processing system to: 1) receive input from the second sensor at the first bottle labeler; 2) determine if the bottle queue is short at the second location; and 3) output a control signal to the first control gate to deliver a predetermined number of bottles when the bottle queue at the second location is short, wherein the system will deliver bottles from the storage container to the first bottle labeler when the processing system determines the first bottle labeler needs more bottles.

6. A bottle delivery system according to claim 1, wherein said first control gate is further comprised of:
a flexible tube for switching the first input port to either the first output port or second output port.

7.-18. (canceled)

19. An object delivery system for delivering objects stored in a storage container to a set of object labelers, comprising:
a first control gate, comprised of a first input port, a first and second output port, a valve for connecting the first input port to the first output port in a first position, and for connecting the first input port to the second output port in a second position;
a first input tube connected to the first input port for delivering objects to the first input port;
a first output tube connected to the first output port wherein objects are delivered to the first output tube when the valve of the first control gate is in a first position;
a second output tube connected to the second output port wherein objects are delivered to the second output tube when the valve of the first control gate is in a second position;
a first object labeler connected to the first output tube;
a first sensor located at a first location at the first object labeler for detecting the presence of an object at the first location;
a processing system in communication with the first sensor, the processing system programmed with one or more software routines executing on the processing system to: 1) receive input from the first sensor at the first object labeler; 2) determine if the object queue is short at the first location; and 3) output a control signal to the first control gate to deliver a predetermined number of objects when the object queue at the first location is short, wherein the system will deliver objects from the storage container to the first labeler when the first sensor determines the first object labeler needs more objects.

20. The object delivery system according to claim 19, further comprising:
a plurality of storage containers for storing objects for delivery;
a plurality of object labelers; and
a plurality of control gates for controlling the delivery of objects from the plurality of storage containers to the plurality of object labelers.

21. The object delivery system according to claim 19, further comprising:
an object orientation device for feeding the objects into the first input tube with openings of the objects pointing up.

22. The object delivery system according to claim 19, further comprising:
a blower for providing air to the system.

23. The object delivery system according to claim 19, further comprising:
a second sensor located at a second location at the first object labeler for detecting the presence of an object at the second location at the first object labeler; and wherein the processing system is programmed with one or more software routines executing on the processing system to: 1) receive input from the second sensor at the second location at the first object labeler; 2) determine if the object queue is short at the second location; and 3) output a control signal to the first control gate to deliver a predetermined number of objects when the object queue at the second location is short, wherein the system will deliver objects from the storage container to the first object labeler when the processing system determines the first object labeler needs more objects.

24. An object delivery system according to claim 19, wherein said first control gate is further comprised of:
a flexible tube for switching the first input port to either the first output port or second output port.

25. A method for delivering bottles stored in a storage container to a set of bottle labelers, comprising:
providing a first control gate, comprised of a first input port, a first and second output port, a valve for connecting the first input port to the first output port in a first position, and for connecting the first input port to the second output port in a second position;
connecting a first input tube to the first input port for delivering bottles to the first input port;
connecting a first output tube to the first output port wherein bottles are delivered to the first output tube when the valve of the first control gate is in a first position;
connecting a second output tube to the second output port wherein bottles are delivered to the second output tube when the valve of the first control gate is in a second position;
connecting a first bottle labeler to the first output tube;
placing a first sensor at a first location at the first bottle labeler;
detecting the presence of a bottle at the first location;
providing a processing system in communication with the first sensor;
receiving input from the first sensor;
determining if the bottle queue is short at the first location;
outputting a control signal to the first control gate to deliver a predetermined number of bottles when the bottle queue at the first location is short,
delivering bottles from the storage container to the first labeler when the first sensor determines the first bottle labeler needs more bottles.

26. The method of claim 25 further comprising the steps of:
placing a second sensor at a second location at the first bottle labeler;
detecting the presence of a bottle at the second location at the first bottle labeler;
receiving input from the second sensor at the second location at the first bottle labeler;
determining if the bottle queue is short at the second location;
outputting a control signal to the first control gate to deliver a predetermined number of bottles when the bottle queue at the second location is short;
delivering bottles from the storage container to the first bottle labeler when the processing system determines the first bottle labeler needs more bottles.
